(19) United States
(12) Patent Application Publication
(10) Pub. No.: US 2026/0065736 A1
(43) Pub. Date: Mar. 5, 2026

(54) Multi-Fluid Dispensing Self Service Station

(71) Applicants: CARLOS MANUEL MARTIN, HOLLYWOOD, FL (US); MARCO ANTONIO MARQUEZ, WINTER GARDEN, FL (US)

(72) Inventors: CARLOS MANUEL MARTIN, HOLLYWOOD, FL (US); MARCO ANTONIO MARQUEZ, WINTER GARDEN, FL (US)

(21) Appl. No.: 18/819,865

(22) Filed: Aug. 29, 2024

(51) Int. Cl. G07F 17/20; B60S 3/00; B60S 3/04; G07F 9/00; G07F 9/02; G07F 13/06; G07F 15/02

(52) U.S. Cl. CPC G07F 17/20; G07F 9/009; G07F 9/023; G07F 13/06; G07F 15/02; B60S 3/008; B60S 3/044

(57) ABSTRACT

A multi-fluid dispenser self service station for automotive cleaning. The system dispenses both a windshield washer fluid and a vehicle interior fluid. The combination of both dispensers allows one to properly clean the windshield and clean the interior of one's vehicle without the need for an attendant. The system provides the user with high quality windshield washer fluid and vehicle interior cleaning solution. The system includes a receptacle, a first and second blend center unit, and a first and second HID. The first blend center unit and the first HID work in tandem to dispense windshield washer solution. Similarly, the second blend center unit and the second HID work in tandem to dispense a cleaning solution for cleaning the vehicle interior. Both types of fluids can be dispensed either in a dispensing container or a spray bottle. The system uses simple, user-interactive, and cost-effective technologies to provide a user-friendly experience.

### FIELD OF THE INVENTION

The present invention relates generally to vehicle servicing tools. More specifically, the present invention is a windshield washer fluid and interior cleaning dispensing self service station for the upkeep and cleaning of vehicles.

### BACKGROUND OF THE INVENTION

While driving in a vehicle, the windshield of the vehicle prevents the driver from being affected by the wind, wildlife, or debris that may otherwise collide with the driver. Because of the purpose the windshield serves, the windshield is frequently covered with dirt or grime from the road, insects struck by the windshield, or other debris. This debris can lead to difficulty seeing through the windshield and concurrently danger while driving. As vehicles have become more and more advanced over the years, windshield wipers and windshield washer fluid dispensers were added. These additions made it possible to clean the windshield of the vehicle at any time while the vehicle is being operated. The windshield wipers of vehicles are effective but are only capable of cleaning a specific area of the windshield. Additionally, the windshield wipers follow a specific pattern which may make it difficult to clean specific areas of the windshield. Windshield washer fluid and tools for cleaning windshields are often available at select gas stations. However, typically the fluid is held within a bucket and may be of low quality. Alternatively, the particular gas station may charge money for the application of fresh, higher quality windshield washer fluid and provision of said fluid by an attendant.

It is an objective of the present invention to offer a solution to the issues mentioned above. The present invention is a multi-fluid dispensing self service station. The present invention attempts to provide a system for applying high quality windshield washer fluid to a vehicle's windshield, as well as a cleaning solution for cleaning the interior of one's vehicle. To accomplish this, the present invention comprises components and utilizes technologies to provide a self-service system that enables users to properly clean the windshield and interior on one's vehicle without the need of an attendant.

### SUMMARY OF THE INVENTION

The present invention is a multi-fluid dispenser self service station for automotive cleaning. Specifically, the present invention dispenses both a windshield washer fluid and a vehicle interior fluid. The combination of both dispensers allows one to properly clean the windshield and clean the interior of one's vehicle without the need for an attendant. The present invention provides a system that is capable of providing a user with high quality windshield washer fluid and vehicle interior cleaning solution.

To accomplish this, the system includes a receptacle, a first and second blend center unit, and a first and second HID (human interface devices). The first blend center unit is designed to dispense windshield washer solution for cleaning windows and the windshield. The second blend center unit is designed to dispense a cleaning solution for cleaning the interior of the vehicle. To that end, the first HID is designed to mix windshield washer concentrate with water to form the windshield washer solution. Similarly, the second HID is designed to mix interior cleaning concentrate with water to form a cleaning solution.

Both types of fluids can be dispensed either in a dispensing container or a spray bottle. Further, the system includes a display device, a payment system (optional), and necessary accessories that help with the smooth functioning of the system. Thus, the device utilizes simple, user-interactive, and cost-effective technologies to provide a multi-fluid dispensing system for automotive cleaning.

### BRIEF DESCRIPTION OF THE DRAWINGS

FIG. 1 is a top front right perspective view of the present invention.

FIG. 2 is a top front right perspective view of the present invention shown without the outer protective covers, to reveal the inner components.

FIG. 3 is a front elevational view of the present invention.

FIG. 4 is a right-side elevational view of the present invention.

FIG. 5 is a top front right perspective view of the receptacle of the present invention.

FIG. 6 is a top front right perspective view of the receptacle of the present invention, shown without the access panel.

FIG. 7 is a top front right perspective view of the receptacle of the present invention, shown without the outer panels, to reveal the inner components.

FIG. 8 is a bottom front left perspective view of the receptacle of the present invention, shown without the outer panels, to reveal the inner components.

FIG. 9 is a front elevational view of the receptacle of the present invention, shown without the outer panels, to reveal the inner components.

FIG. 10 is a top front right perspective view of the present invention, shown in a wall-mount configuration.

FIG. 11 is a right-side elevational view of the present invention, shown in a wall-mount configuration.

FIG. 12 is a top front left perspective view of the present invention, shown in a pedestal-mount and tank configuration.

FIG. 13 is a top front left perspective view of the present invention shown in a pedestal-mount and tank configuration, without the outer panels to reveal the inner components.

FIG. 14 is a top front right perspective view of the present invention shown in a pedestal-mount and tank configuration, without the outer panels to reveal the inner components.

FIG. 15 is a top front right perspective view of the receptacle of the present invention shown in a pedestal-mount and tank configuration, without the outer panels to reveal the inner components.

FIG. 16 is a bottom front left perspective view of the receptacle of the present invention shown in a pedestal-mount and tank configuration, without the outer panels to reveal the inner components.

FIG. 17 is a front elevational view of the receptacle of the present invention shown in a pedestal-mount and tank configuration, without the outer panels to reveal the inner components.

FIG. 18 is a block diagram of the electrical and electronic components of the present inventions, wherein thicker lines represent electronic connection, thinner lines represent electrical connections, and broken lines represent wireless connections.

### DETAILED DESCRIPTION OF THE INVENTION

All illustrations of the drawings are for the purpose of describing selected versions of the present invention and are not intended to limit the scope of the present invention.

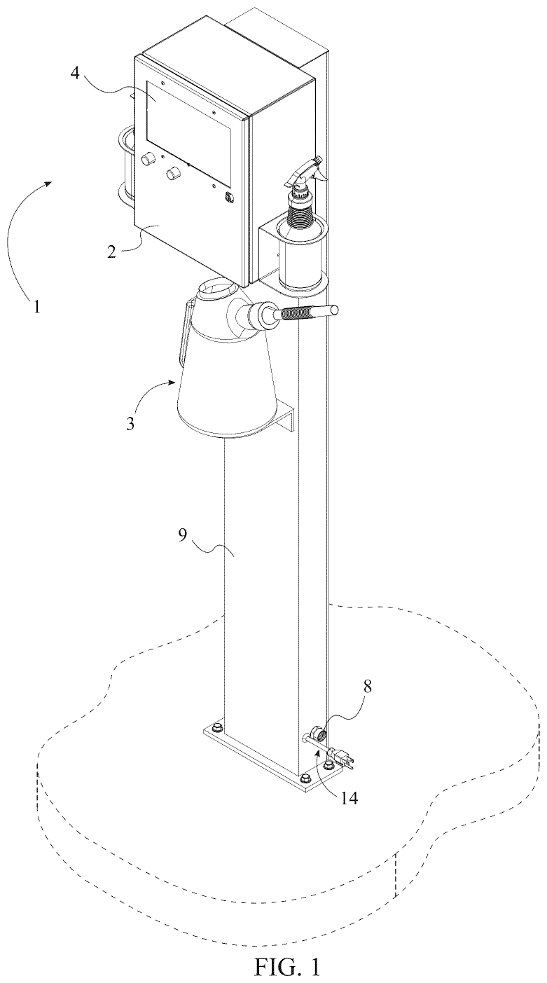

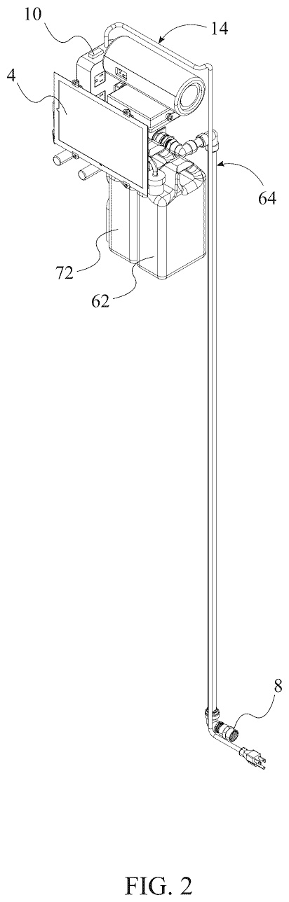

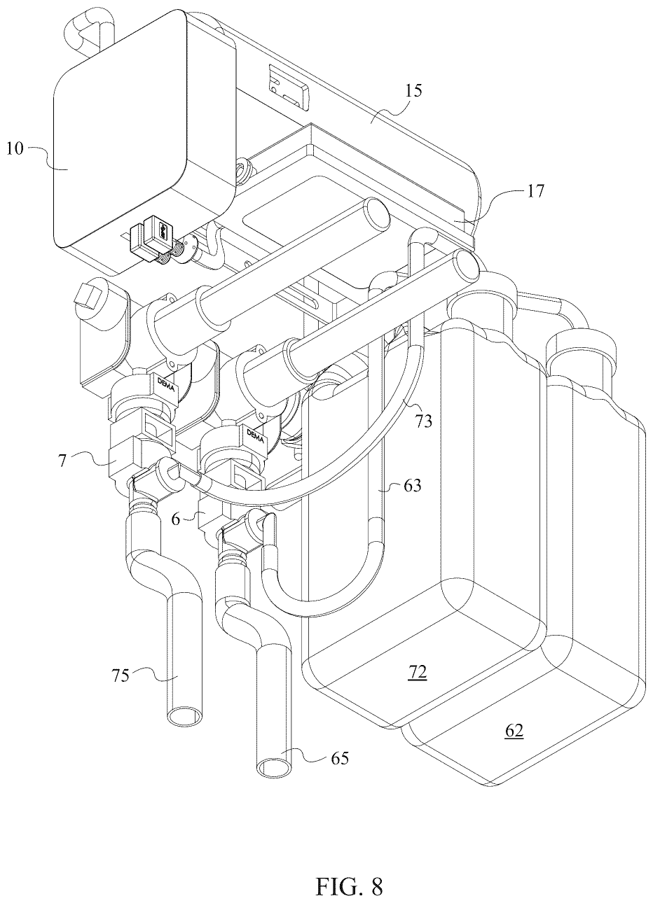

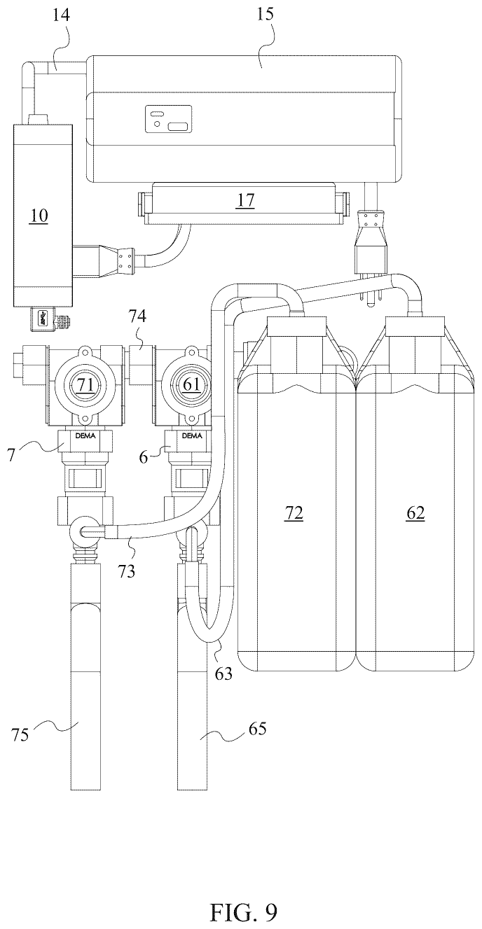

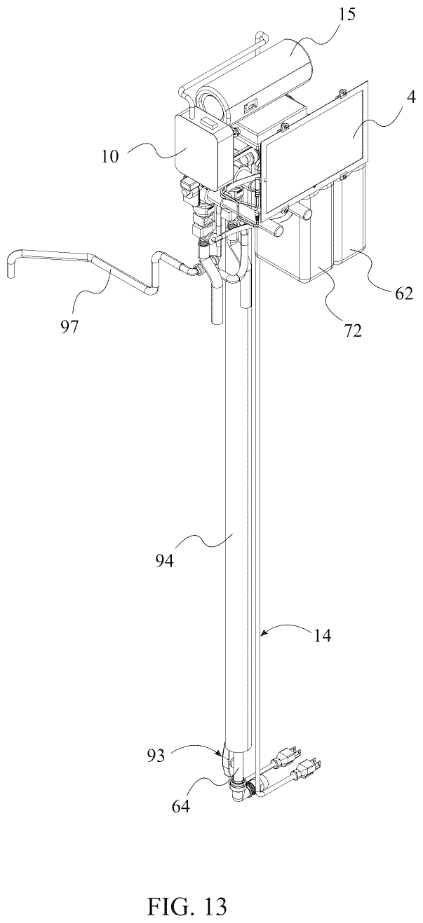

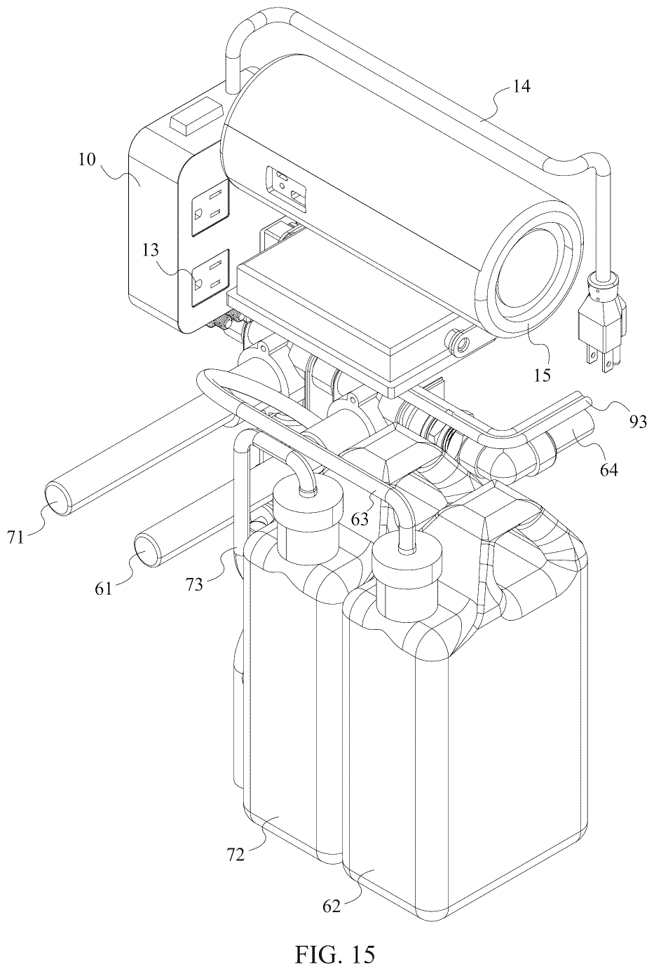

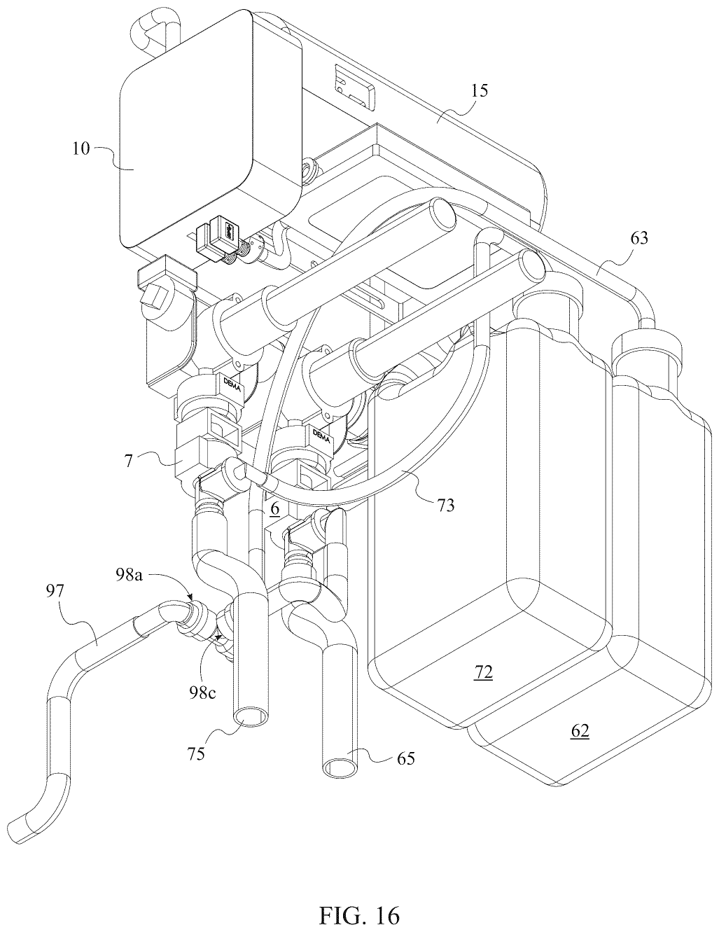

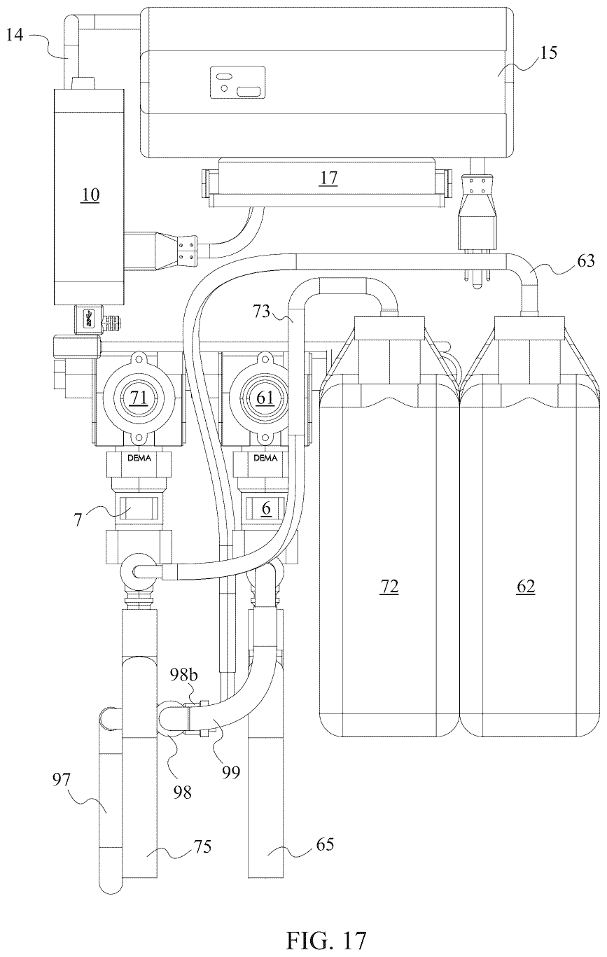

In reference to FIG. 1 through FIG. 18, the present invention is a self-service dispensing system that allows a user to clean multiple areas of their vehicle without the need for an attendant. The entire dispensing system is housed within a receptacle that is mounted either to a wall or pedestal. The receptacle itself incorporates simple, user-interactive, and cost-effective technologies to provide a user-friendly experience. The present invention allows a user to dispense high quality windshield washer fluid into a dispensing container for the purpose of cleaning the windshield. In addition, the user has the option to separately dispense a cleaning solution into a spray bottle for the purpose of cleaning the interior of their vehicle.

To utilize the dispensing system, a specific method must be performed. The electronic components of the present invention may be powered via a power source and the power cord extending from the back side of the body of the receptacle. The display device or tablet is activated automatically once the camera on the tablet captures motion and displays operating instructions and advertisements during the dispensing process. In one embodiment, the user may use a card reader to pay for the specific amount windshield washer fluid about to be used by tapping one's credit or debit card against the card reader. In another embodiment, the payment system uses a QR code for scanning with a phone camera, rather than using a card reader. In yet another embodiment, payment is not required, and the user can use the dispensing system free of charge.

The present invention mixes highly concentrated windshield washer liquid from a container with water from the hose inlet water supply. The activation button may be pressed and held down to activate the blend center unit. The concentrate suction tube draws concentrate from the container, created as the water from the hose inlet water supply flows through the blend center unit and mixes with the water from the hose inlet water supply, by means of siphoning. The mixed product dispenser tube releases the mixed product through the opening of the dispensing container and fills the dispensing container with the proper mixture. A separate but similar blend center unit is also housed in the receptacle and is used for mixing highly concentrated cleaning solution with water for the purpose of cleaning the interior of the vehicle.

Depending on the amount of fluid dispensed into the dispenser container, one will be charged a specific amount of money to one's credit or debit card (payment version only). Once the desired amount of fluid has been produced, one can relieve the activation button of pressure. The solenoid valve then closes, preventing fluid from entering the blend center unit and stopping the blend center unit from running. The dispenser container may then be picked up and removed from the shelf via the handle. When one would like to dispense the fluid from the dispenser container, one can tilt the dispenser container at an angle so that fluid is spilled from the spout. Alternatively, the user can dispense either the windshield washer fluid or cleaning solution into a spray bottle in lieu of the dispenser container.

Regarding installation, the present invention incorporates at least four possible mounting configurations, depending on the user's preference and/or design requirements. This includes a wall mount configuration and a pedestal mount configuration. For each of these configurations, the user has the option to install a methanol tank and heating system for the purpose of keeping the windshield washer fluid at optimal temperature during extreme cold temperatures. The heating element prevents water from the supply line from freezing during the winter months. The methanol mixed with concentrate and water keeps the finished product from freezing in the car's reservoir.

The following description is in reference to FIG. 1 through FIG. 18. According to a preferred embodiment, the present invention comprises a receptacle 1, an access panel 2, at least one liquid dispenser 3, a display device 4, a user detecting device 41, a microcontroller 5, a first blend center unit 6, a first HID (human interface device) 61, a second blend center unit 7, and a second HID (human interface device) 71. As seen in FIG. 1, the receptacle 1 functions as the primary structural component of the present invention. Further, the receptacle 1 can be detachably mounted to various types of structures 9, depending on design, user, and/or manufacturing requirements. The receptacle 1 is a rectangular box that acts as a protective outer covering and main body of the present invention. Accordingly, the receptacle 1 is made of a plurality of rectangular panels that are made of a sturdy solid material such as metal and arranged in such a way to form the rectangular box or body. Preferably, the receptacle 1 is composed of proprietary anodized aluminum extrusion assembled into the shape of a vertical rectangular prism as shown in FIG. 1. In the preferred embodiment, the plurality of panels consists of three-millimeter ACM panels. However, the receptacle 1 may comprise any other material, shape, components, and arrangement of components that are known to one of ordinary skill in the art, as long as the intents of the present invention are not altered.

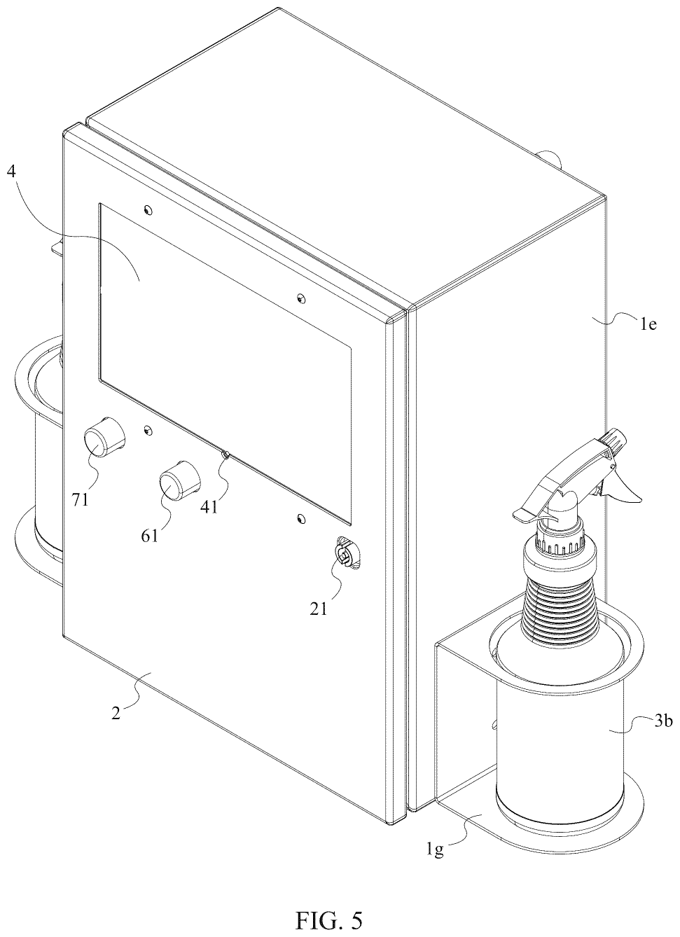

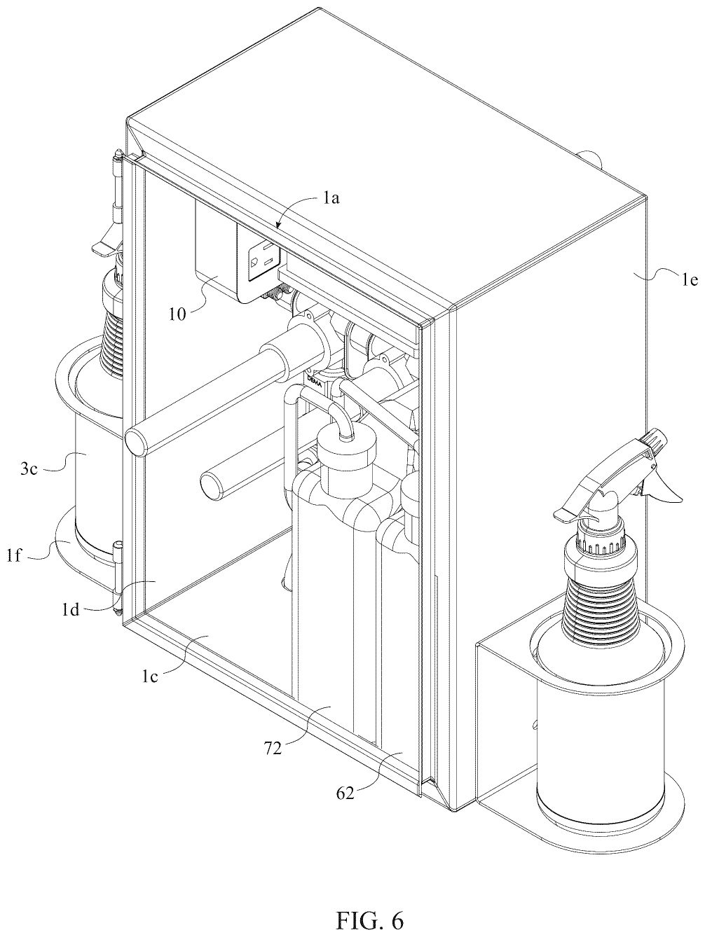

As seen in FIGS. 5 and 6, according to the preferred embodiment, the plurality of panels encloses an internal portion of the present invention. To that end, the receptacle comprises a front opening 1a, a back side 1b, a bottom side 1c, a first side 1d, and a second side 1e. Preferably, the first side 1d constitutes a left-side of the receptacle 1 and the second side 1e constitutes a right-side of the receptacle 1. However, in other embodiments, the arrangement may be switched such that the first side 1d constitutes the right-side of the receptacle 1 and the second side 1e constitutes the left-side of the receptacle 1. In either arrangement, the first side 1d is positioned opposite to the second side 1e across the receptacle 1. In the preferred embodiment, the receptacle further comprises a pair of holders, designated as a first holder 1f and a second holder 1g. The first holder 1f is mounted to the first side 1d of the receptacle, whereas the second holder 1g is mounted to the second side 1e of the receptacle 1. In this arrangement, the holders can be used to store spray bottles or any other type of container.

As seen in FIGS. 5 and 6, the access panel 2 is laterally integrated onto the receptacle 1. Operating the access panel 2 enables access to the interior of the receptacle 1, which in turn, allows the user to perform maintenance and/or refill the concentrate containers. To that end, the access panel 2 is operably coupled to the receptacle 1 via a hinge mechanism. However, the means of operating the access panel 2 is not limited to a hinge mechanism, and may include any other form known in the art including but not limited to click locks, mechanical fasteners, and/or slotted keyways. In the preferred embodiment, a security lock 21 is also laterally integrated into the access panel 2, thereby restricting access to authorized users only. Preferably, the security lock 21 is a cam lock that requires a specialized key for unlocking. However, the type of lock is not limited to a cam lock, and may include any other type of lock known in the art capable of achieving the same result.

Additionally, residing on the access panel 2 is the display device 4. In other words, the display device 4 is laterally integrated onto the access panel 2. The display device 4 is an electronic component capable of displaying advertisements. Preferably, the display device 4 is a tablet run by the Android operating system. Further, the user detecting device 41 is preferably a camera that is integrated into the display device 4. In another embodiment, the user detecting device 41 may be at least one wireless sensor, that can detect the presence of a user through motion sensing, face recognition, blue tooth activation, voice activation etc. However, the display device 4 and the user detecting device 41 may comprise any other brand, size, shape, technology, components, arrangement of components etc. that are known to one of ordinary skill in the art, as long as the intents of the present invention are not altered. To enable smooth functioning, the display device 4 and the user detecting device 41 are electronically coupled to the microcontroller 5. This is so that when the user detecting device 41 detects the presence of a user, a signal is sent to the display device 4 through the microcontroller 5 and the display device 4 turns active. In other words, the display device 4 is operably coupled to the user detecting device 41, wherein the display device 4 is actuated by the user detecting device 41. To that end, the microcontroller 5 is a processing device that manages the operation of the electrical components within the present invention. The microcontroller 5 is an integrated circuit that may comprise any brand, size, components, arrangement of components etc. that are known to one of ordinary skill in the art, as long as the intents of the present invention are not altered.

In the preferred embodiment, the first HID 61 is a small circular component accessible via the front side of the receptacle 1. In other words, the first HID 61 is laterally integrated onto the access panel 2 and is a circular button. The first HID 61 is a part of the first blend center unit 6, and accordingly, the first blend center unit 6 is mounted adjacent to the first HID 61. As best seen in FIG. 6, the first blend center unit 6 resides within the receptacle 1 and is primarily a rectangular prism in shape. According to the preferred embodiment, the first HID 61 is operably coupled to the first blend center unit 6, wherein operating the first HID 61 governs dispensing of a windshield washer solution from the first blend center unit into the at least one liquid dispenser 3. In other words, the windshield washer solution located at the first blend center unit 6 will be dispensed into the at least one liquid dispenser 3 when the user operates the first HID 6 or pushes the circular button. On releasing the first HID 6, dispensing of the windshield washer solution stops. To enable this, on the paid version units only, a solenoid valve is integrated onto the first HID 6. However, the first HID 6 may have any other shape and technology, such as voice activation, a pulling lever etc., that are known to one of ordinary skill in the art, as long as the objectives of the present invention are fulfilled.

Regarding the plumbing for the first blend center unit 6, according to the preferred embodiment, the present invention further comprises a first concentrate container 62, a first concentrate suction tube 63, a water supply tube 64, and a first mixed product dispenser tube 65. Preferably, each of the first concentrate container 62, the first concentrate suction tube 63, and the water supply tube 64 are mounted within the receptacle 1. As seen in FIG. 6, the first concentrate container 62 is detachably mounted to the bottom side 1c of the receptacle 1. This arrangement provides easy access, allowing the user to quickly replace or refill the first concentrate container 62 when necessary. In the preferred embodiment, the first concentrate container 62 is large enough to hold a sufficient amount of windshield washer fluid concentrate while being small enough to be accessed or removed through the front opening 1a of the receptacle 1.

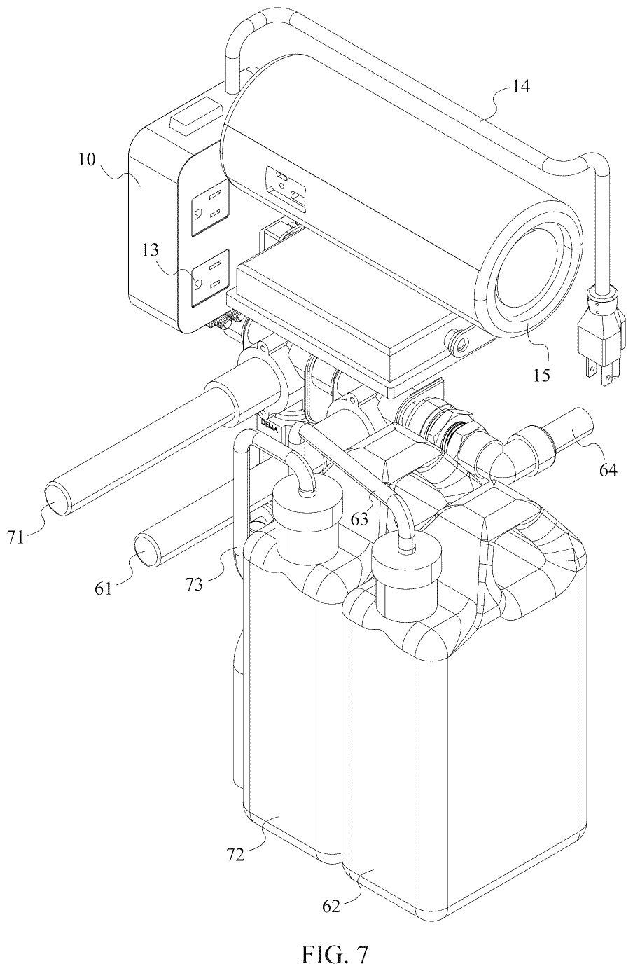

As seen in FIGS. 7-9, rising vertically from the first concentrate container 62 and connecting to the first blend center unit 6 is the first concentrate suction tube 63. The first concentrate suction tube 63 is a portion of a cylindrical tubing that is in fluid communication with the first concentrate container 62 and the first blend center unit 6. Also connected to the first blend center unit 6 is the water supply tube 12. In other words, the first blend center unit 6 is in fluid communication with the first concentrate suction tube 63 and the water supply tube 64. Extending downward from the first blend center unit 6 to the top of the at least one liquid dispenser 3 is a straight, cylindrical component referred to as the first mixed product dispenser tube 65. In other words, the first mixed product dispenser tube 65 extends from the first blend center unit 6, and the first mixed product dispenser tube 65 is oriented towards the at least one liquid dispenser 3. This arrangement is so that a specific set of functions may be performed for the smooth operation of the self-service windshield washer dispensing station. More specifically, when the first HID 61 or activation button is pressed and held down to activate the first blend center unit 6, the first concentrate suction tube 63 draws concentrate from the first concentrate container 62. This is enabled as the water from the water supply tube 64 flows through the first blend center unit 6. Further, at the first blend center unit 6, the concentrate mixes with the water from the water supply tube 64 by means of siphoning. Subsequently, the first mixed product dispenser tube 65 releases the windshield washer fluid into the at least one liquid dispenser 3.

Similarly, in the preferred embodiment, the second HID 71 is a small circular component accessible via the front side of the receptacle 1. In other words, the second HID 71 is laterally integrated onto the access panel 2 and is a circular button. The second HID 71 is a part of the second blend center unit 7, and accordingly the second blend center unit 7 is mounted adjacent to the second HID 71. As best seen in FIG. 6, the second blend center unit 7 resides within the receptacle 1 and is primarily a rectangular prism in shape. According to the preferred embodiment, the second HID 71 is operably coupled to the second blend center unit 7, wherein operating the second HID 71 governs dispensing of a cleaning solution from the second blend center unit into the at least one liquid dispenser 3. In other words, the cleaning solution located at the second blend center unit 7 will be dispensed into the at least one liquid dispenser 3 when the user operates the second HID 7 or pushes the circular button. On releasing the second HID 7, dispensing of the cleaning solution stops. To enable this, on the paid version units only, a solenoid valve is integrated onto the second HID 7. However, the second HID 7 may have any other shape and technology, such as voice activation, a pulling lever etc., that are known to one of ordinary skill in the art, as long as the objectives of the present invention are fulfilled.

Regarding the plumbing for the second blend center unit 7, according to the preferred embodiment, the present invention further comprises a second concentrate container 72, a second concentrate suction tube 73, and a second mixed product dispenser tube 75. Preferably, the second concentrate container 72 and the second concentrate suction tube 73 are mounted within the receptacle 1. As seen in FIG. 6, the second concentrate container 72 is detachably mounted to the bottom side 1c of the receptacle 1. This arrangement provides easy access, allowing the user to quickly replace or refill the second concentrate container 72 when necessary. In the preferred embodiment, the second concentrate container 72 is large enough to hold a sufficient amount of cleaning concentrate while being small enough to be accessed or removed through the front opening 1a of the receptacle 1.

As seen in FIGS. 7-9, rising vertically from the second concentrate container 72 and connecting to the second blend center unit 7 is the second concentrate suction tube 73. The second concentrate suction tube 73 is a portion of a cylindrical tubing that is in fluid communication with the second concentrate container 72 and the second blend center unit 7. The second blend center unit 7 is adjacently connected to the second blend center unit 6 via an adjoining pipe segment 74, such that a portion of the water entering the first blend center unit 6 from the water supply tube 64 flows through the pipe segment 74 and enters the second blend center unit 7. Thus, the second blend center unit 7 is in fluid communication with the second concentrate suction tube 73, the first blend center unit 6, and the water supply tube 64. Extending downward from the second blend center unit 7 to the top of the at least one liquid dispenser 3 is a straight, cylindrical component referred to as the second mixed product dispenser tube 75. In other words, the second mixed product dispenser tube 75 extends from the second blend center unit 7, and the second mixed product dispenser tube 75 is oriented towards the at least one liquid dispenser 3. This arrangement is so that a specific set of functions may be performed for the smooth operation of the self-service interior cleaning dispensing station. More specifically, when the second HID 71 or activation button is pressed and held down to activate the second blend center unit 7, the second concentrate suction tube 73 draws concentrate from the second concentrate container 72. This is enabled as the water from the water supply tube 64 flows through the first blend center unit 6, through the adjoining pipe segment 74, and through the second blend center unit 7. Further, at the second blend center unit 7, the concentrate mixes with the water from the water supply tube 64 by means of siphoning. Subsequently, the second mixed product dispenser tube 75 releases the cleaning solution into the at least one liquid dispenser 3.

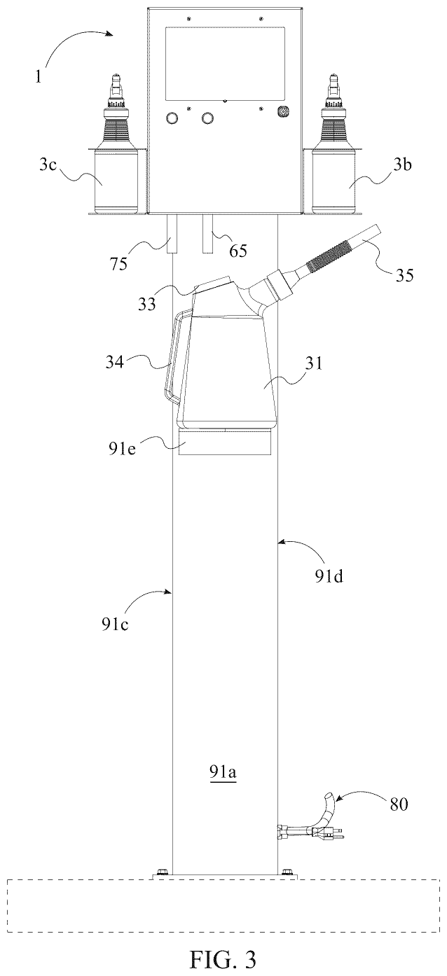

In the preferred embodiment, as best seen in FIG. 3, the at least one liquid dispenser 3 comprises a dispenser container 3a, a first spray bottle 3b, and a second spray bottle 3c. Each of the first and second spray bottles 3a and 3b can be detachably mounted to the first and second holders 1f and 1g. The dispenser container 3a can be detachably mounted to a shelf below the receptacle 1. To that end, the dispenser container 3a comprises a container body 31, an internal compartment 32, a mouth 33, a handle 34, and a spout 35. In the preferred embodiment, the internal compartment 32 traverses into the container body 31. Further, the mouth 33 is oriented towards the first mixed product dispenser tube 65, wherein the mouth 33 provides access into the internal compartment 32. This is so that the first mixed product dispenser tube 65 may release the windshield washer solution into the dispenser container 3a through the mouth 33 of the dispenser container 3a and fill the internal compartment 32 with the proper mixture. For easy handling by the user, the handle 34 is laterally mounted onto the container body 31. For pouring out the windshield washer fluid onto the vehicle windshield in a controlled manner, the spout 35 laterally extends from the container body 31 opposite to the handle 34, and the spout 35 is in fluid communication with the internal compartment 32.

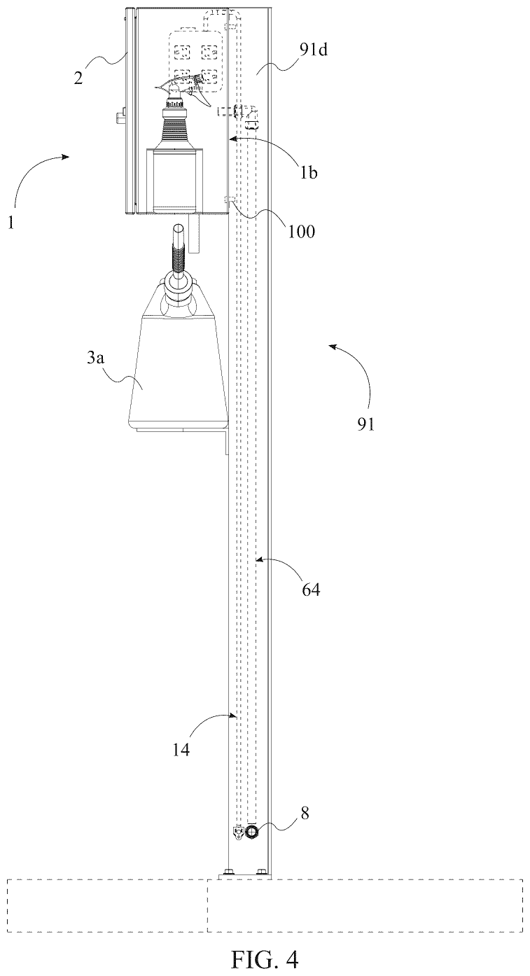

In order to supply water to the water supply tube 64, the water supply tube 64 is connected to an external water source. As best seen in FIGS. 3-4, the present invention further comprises a water inlet valve 8 and an inlet water source 80. Preferably, the inlet water source 80 is a hose that is connected to an external water source such as a water tank or tap. For smooth operation of the system, the water supply tube 64 is connected to the inlet water source 80 via the water inlet valve 8.

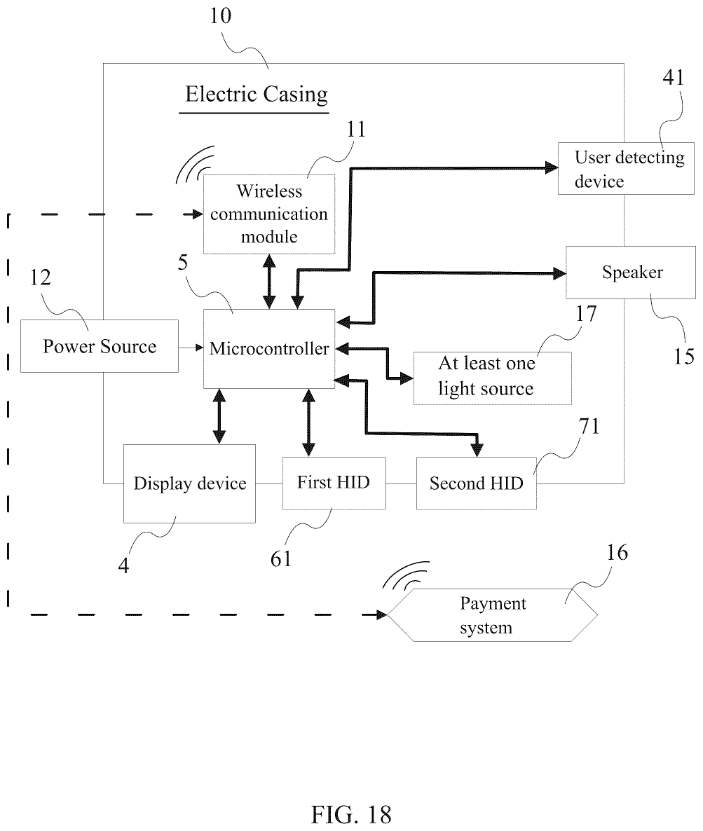

In reference to FIG. 18, the present invention comprises an electric casing 10, a wireless communication module 11, and a power source 12. Preferably, the electric casing 10 is mounted within the receptacle 1, and the microcontroller 5, the wireless communication module 11, and the power source 12 are each mounted within the electric casing 10. This is so that the sensitive electrical components may be safely arranged in a secured box and protected from hazardous outside elements such as pipes containing pressurized liquid. It is an aim of the present invention to incorporate wireless activations and operations such as voice activation, blue tooth activation, face recognition etc. To that end, the wireless communication module 11 is electronically connected to the microcontroller 5. In other words, the microcontroller 5 may comprise a wireless communication module, that connects and communicates with external devices via wireless data transmission protocols. Example standards of what the wireless communication module 11 is capable of using includes, but are not limited to, Bluetooth, WI-FI, GSM, CDMA, ZigBee, etc. In order to provide electrical power to the electric components of the present invention, the power source 12 is electrically connected to the microcontroller 5. Preferably, the power source 12 is an electrical power strip with surge protection. However, any other source of power, or a combination of the following sources may be employed for the smooth functioning of the present invention. Examples of such power sources include, but are not limited to, Li ion batteries, magnetic power converters, solar power converters, etc. In the preferred embodiment, as seen in FIG. 7, the present invention further comprises at least one electrical terminal 13 integrated into the electric casing 10. The at least one electrical terminal 13 allows the present invention to receive electrical power from an external power supply, and/or send electrical power to an external electrical load. To that end, the present invention comprises a power cord 14, wherein the power cord 14 is electrically connected to the power source 12. The power cord 14 extends out of the receptacle 1.

Continuing with the preferred embodiment, the present invention further comprises a speaker 15, and the speaker 15 is electronically connected to the microcontroller 5. In this arrangement, the speaker 15 may provide audio for the advertisements being shown on the display device 4, or any other programmed commands.

It is an objective of the present invention to enable both paid and unpaid versions for the service station. Accordingly, the present invention may comprise a payment system 16, wherein the payment system 16 is electronically connected to the microcontroller 5. For example, the payment system 16 may be a card reader, a scanner code, a number, or any other technology that is known to one of ordinary skill in the art, as long as the intents of the present invention are not altered.

To provide necessary illumination for guidance as well as decorative purposes, the present invention comprises at least one light source 17. Preferably, the light source 17 is electronically connected to the microcontroller 5 and the light source 17 is mounted within the receptacle 1, thereby illuminating the various components housed inside the receptacle 1. The at least one light source 17 may comprise any color, power source, location etc. as long as the intents of the present invention are not altered.

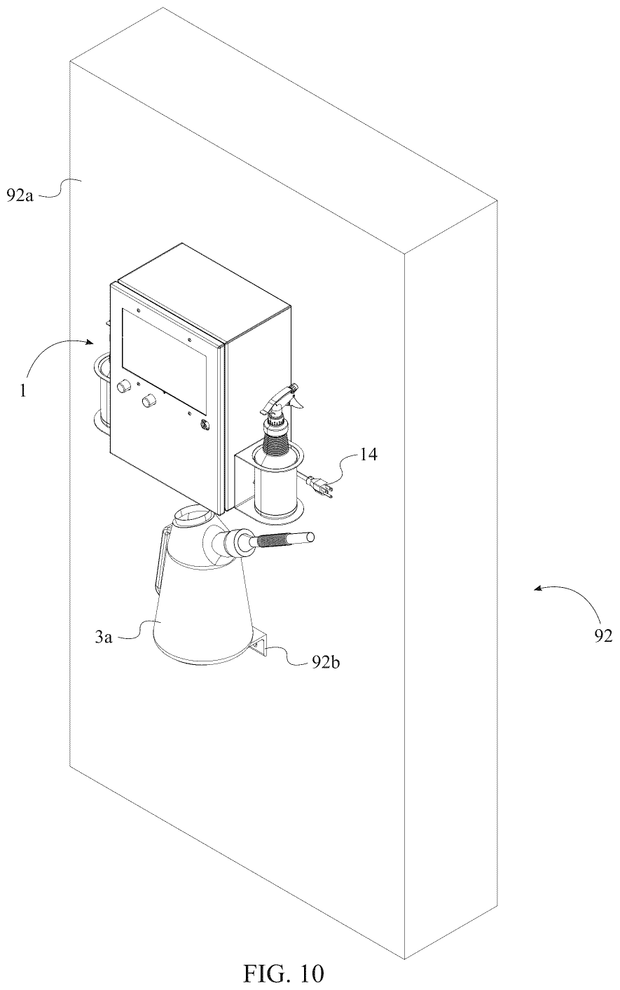

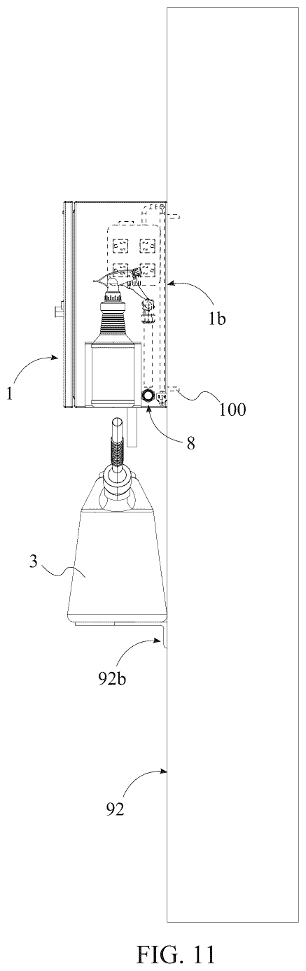

As previously mentioned above, the receptacle 1 can be detachably mounted to various types of structures 9, depending on design, user, and/or manufacturing requirements. In a first embodiment, in reference to FIGS. 10 and 11, the structure is a wall, wherein the back side 1b of the receptacle 1 is detachably mounted to the front surface 92a of the wall 92 via a plurality of fasteners 100. A shelf 92b is mounted to the front surface 92a of the wall, positioned below and centered with the receptacle 1. Thus, the shelf 92b can be used to hold the at least one liquid dispenser 3 during filling. With regard to the water supply, the water inlet valve 8 can be mounted either to the first side 1d or the second side 1e of the receptacle 1.

In a second embodiment, in reference to FIGS. 1-4, the receptacle is mounted to a pedestal 91. To that end, the pedestal 91 comprises a front side 91a, a back side 91b, a first side 91c, and a second side 91d. Preferably, the first side 91c constitutes a left-side of the pedestal and the second side 91d constitutes a right-side of the pedestal. However, in other embodiments, the arrangement may be switched such that the first side 91c constitutes the right-side of the pedestal and the second side 91d constitutes the left-side of the pedestal. Thus, in either arrangement, the first side 91c is positioned opposite to the second side 91d across the pedestal 91.

Continuing with the second embodiment, the pedestal 91 further includes a shelf 91e mounted to the front side 91a, positioned below and centered with the receptacle 1. The back side 1b of the receptacle is detachably mounted to the front side 91a of the pedestal via a plurality of fasteners 100. With regard to water supply, the water inlet valve 8 can be mounted either to the first side 91c or the second side 91d of the pedestal 91, preferably near the bottom of the pedestal as seen in FIG. 4. To that end, the water supply tube 64 has an extended length capable of traversing through the back side 1b of the receptacle 1, through the front side 91a of the pedestal 91, and connect to the water inlet valve 8.

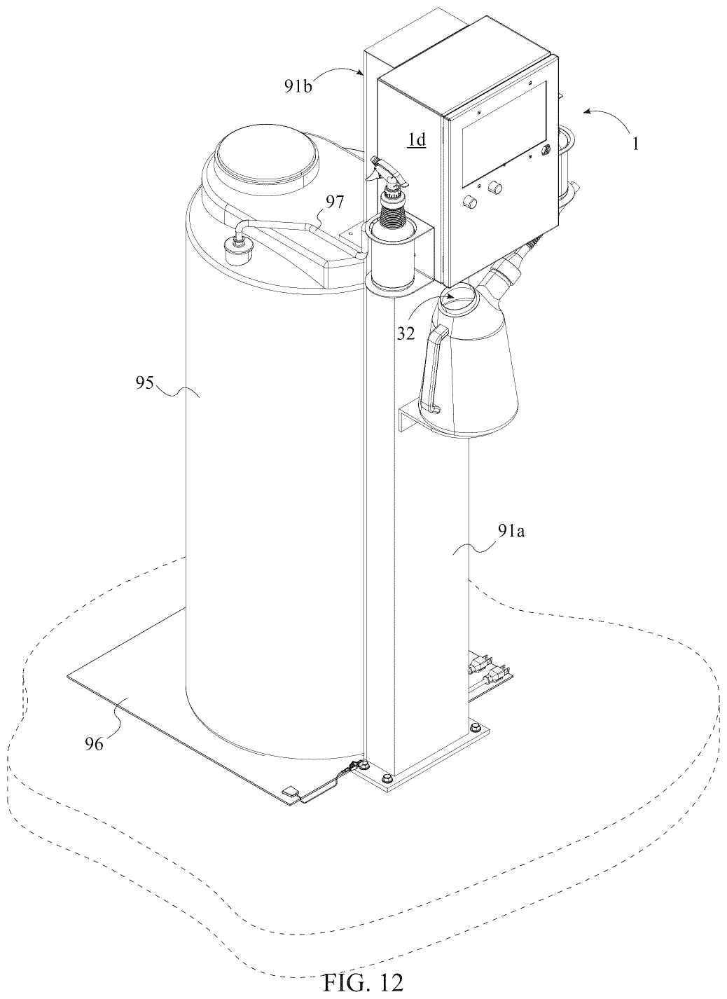

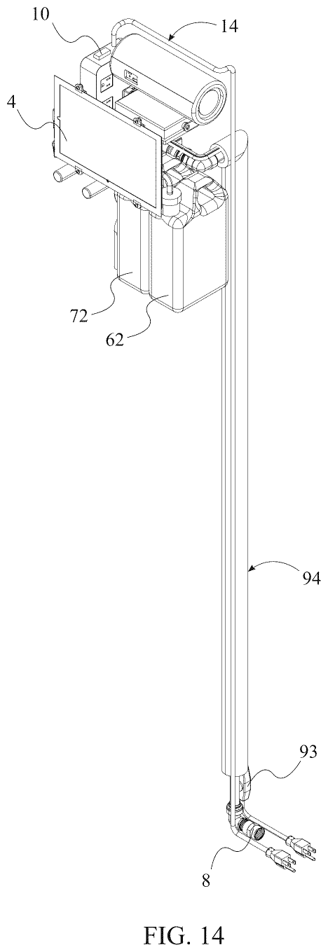

In a third embodiment, in reference to FIGS. 12-17, the present invention can further be configured to function in below freezing temperatures. In this embodiment, the present invention incorporates a heating system for heating the water supply tube 64. To that end, the present invention further comprises an electric heater 93 and pipe insulation 94. The electric heater 93 extends along the water supply tube 64, adjacent to one another. As best seen in FIG. 14, the pipe insulation 94 surrounds both the water supply tube 64 and the electric heater 93. In this arrangement, the electric heater 93 and the pipe insulation 94 work in tandem to prevent water from freezing within the water supply tube 64.

Continuing with the third embodiment, the present invention further incorporates an external tank system for supplying an anti-freezing agent to the windshield washer fluid. To that end, the present invention further comprises a storage tank 95 and an anti-static rubber mat 96. As seen in FIG. 12, the anti-static rubber mat 96 functions as a consistent ground path for static electricity, thereby eliminating the risk of fire and/or explosion caused by electrostatic discharge. To that end, the anti-static rubber mat 96 surrounds the bottom of the storage tank 95. The storage tank 95 is mounted to the back side of either the pedestal 91 or the wall 92, depending on user preference. Preferably, the storage tank 95 holds methanol for use as an anti-freezing agent in the windshield washer solution. However, other types of antifreeze liquid can be used as long as the intents of the present invention are not altered.

Continuing with the third embodiment, with regard to plumbing, the present invention further comprises a storage tank tube 97, a mixing valve 98, and a mixed solution tube 99. To transfer the methanol out of the storage tank 95 and into the mixing valve 98, the storage tank 95 is in fluid communication with the mixing valve 98 via the storage tank tube 97. Specifically, the storage tank tube 97 connects to a first inlet 98a of the mixing valve 98. The mixing valve 98 is preferably positioned within the receptacle 1. The first concentrate container 62 is also in fluid communication with the mixing valve 98 via the first concentrate suction tube 63. Specifically, the first concentrate suction tube 63 is connected to a second inlet 98b of the mixing valve 98. In this arrangement, the mixing valve 98 is designed to add methanol to the windshield washer fluid concentrate before being mixed with water.

Continuing with the third embodiment, to transfer the mixed solution into the first blend center unit 6, the mixing valve 98 is in fluid communication with the first blend center unit 6 via the mixed solution tube 99. Specifically, the mixed solution tube 99 extends from an outlet 98c of the mixing valve 98 and connects to the first blend center unit 6. Thus, the mixed solution enters the first blend center unit 6 where it is combined with water to produce the windshield washer solution. The first mixed product dispenser tube 65 then releases the windshield washer solution into the at least one liquid dispenser 3, where it is then ready to be dispensed onto to the user's windshield. Since the windshield washer solution contains a methanol additive, the user can clean their windshield even in below freezing temperatures.

Although the invention has been explained in relation to its preferred embodiment, it is to be understood that many other possible modifications and variations can be made without departing from the spirit and scope of the invention as hereinafter claimed.

What is claimed is:

1. A dispensing system for vehicle cleaning, the dispensing system comprising:
a receptacle;
an access panel;
at least one liquid dispenser;
a display device;
a user detecting device;
a microcontroller;
a first blend center unit;
a first HID (human interface device);
the receptacle comprising a front opening;
the access panel being laterally integrated onto the front opening;
the first HID, the display device, and the user detecting device being laterally integrated onto the access panel;
the display device and the user detecting device being electronically coupled to the microcontroller;
the display device being operably coupled to the user detecting device, wherein the display device is actuated by the user detecting device;
the first blend center unit being mounted adjacent to the first HID; and
the first HID being operably coupled to the first blend center unit, wherein operating the first HID governs dispensing of a windshield washer solution from the first blend center unit into the at least one liquid dispenser.

2. The dispensing system of claim 1, comprising:
a first concentrate container;
a first concentrate suction tube;
a water supply tube;
a first mixed product dispenser tube;
the first concentrate container, the first concentrate suction tube, and the water supply tube being mounted within the receptacle;
the first concentrate container being mounted adjacent to the bottom side of the receptacle;
the first concentrate suction tube being in fluid communication with the first concentrate container and the first blend center unit;
the first blend center unit being in fluid communication with the first concentrate suction tube and the water supply tube;
the first mixed product dispenser tube extending from the first blend center unit, wherein the first mixed product dispenser tube is in fluid communication with the first blend center unit; and
the first mixed product dispenser tube being oriented towards the at least one liquid dispenser.

3. The dispensing system of claim 2, comprising:
a wall;
a shelf;
a water inlet valve;
an inlet water source;
the back side of the receptacle being detachably mounted to a front side of the wall via a plurality of fasteners;
the shelf being mounted to the wall, positioned below the receptacle;
the water inlet valve being mounted to the side of the receptacle; and
the water supply tube being connected to the inlet water source through the water inlet valve.

4. The dispensing system of claim 2, comprising:
a pedestal;
a shelf;
a water inlet valve;
an inlet water source;
the back side of the receptacle being detachably mounted to a front side of the pedestal via a plurality of fasteners;
the shelf being mounted to the pedestal, positioned below the receptacle;
the water supply tube traversing through the back side of the receptacle;
the water supply tube being connected to the water inlet valve;
the water inlet valve being mounted to the side of the pedestal; and
the water supply tube being connected to the inlet water source via the water inlet valve.

5. The dispensing system of claim 2, comprising:
a pedestal;
a shelf;
a storage tank;
a storage tank tube;
a mixing valve;
a mixed solution tube;
the storage tank containing an anti-freeze liquid;
the storage tank tube being connected to a first inlet of the mixing valve;
the first concentrate suction tube being connected to a second inlet of the mixing valve;
the storage tank being in fluid communication with the mixing valve via the storage tank tube;
the mixing valve being in fluid communication with the first blend center unit via the mixed solution tube;
the back side of the receptacle being detachably mounted to a front side of the pedestal via a plurality of fasteners; and
the shelf being mounted to the pedestal, positioned below the receptacle.

6. The dispensing system of claim 5, comprising:
a water inlet valve;
an inlet water source;
an electric heater;
the water inlet valve being mounted to the side of the pedestal;
the water supply tube traversing into the pedestal and connecting to the water inlet valve;
the electric heater being positioned adjacent to the water supply tube; and
the water supply tube being connected to the inlet water source through the water inlet valve.

7. The dispensing system of claim 1, comprising:
a second blend center unit;
a second HID (human interface device);
the second HID being laterally integrated onto the access panel;
the second blend center unit being mounted adjacent to the second HID; and;
the second HID being operably coupled to the second blend center unit, wherein operating the second HID governs dispensing of a cleaning solution from the second blend center unit into the at least one liquid dispenser.

8. The dispensing system of claim 7, comprising:
a second concentrate container;
a second concentrate suction tube;
a water supply tube;
a second mixed product dispenser tube;
the second concentrate container, the second concentrate suction tube, and the water supply tube being mounted within the receptacle;
the second concentrate container being mounted adjacent to the bottom side of the receptacle;
the second concentrate suction tube being in fluid communication with the second concentrate container and the second blend center unit;
the second blend center unit being in fluid communication with the second concentrate suction tube and the water supply tube;
the second mixed product dispenser tube extending from the second blend center unit, wherein the second mixed product dispenser tube is in fluid communication with the second blend center unit; and
the second mixed product dispenser tube being oriented towards the at least one liquid dispenser.

9. The dispensing system of claim 2, comprising:
the at least one liquid dispenser being a dispenser container;
the dispenser container comprising a container body, an internal component, a mouth, a handle, and a spout;
the internal compartment traversing into the container body;
the mouth being oriented towards the first mixed product dispenser tube;
the mouth providing access into the internal compartment;
the handle laterally mounted onto the container body;
the spout being laterally extending from the container body opposite to the handle; and
the spout being in fluid communication with the internal compartment.

10. The dispensing system of claim 1, comprising:
an electric casing;
a wireless communication module;
a power source;
a power cord;
the electric casing being mounted within the receptacle;
the microcontroller, the wireless communication module, and the power source being mounted within the electric casing;
the wireless communication module being electronically connected to the microcontroller;
the power source being electrically connected to the microcontroller;
the power cord being electrically connected to the power source; and
the power cord extending out of the receptacle.

11. The dispensing system of claim 1, comprising:
a speaker; and
the speaker being electronically connected to the microcontroller.

12. The dispensing system of claim 1, comprising:
the access panel being operably coupled to the receptacle, wherein operating the access panel enables access into the receptacle.

13. The dispensing system of claim 1, comprising:
a payment system; and
the payment system being electronically connected to the microcontroller.

14. The dispensing system of claim 1, comprising:
at least one light source;
the light source being electronically connected to the microcontroller; and
the light source being mounted within the receptacle.

15. A dispensing system for vehicle cleaning, the dispensing system comprising:
a receptacle;
an access panel;
at least one liquid dispenser;
a display device;
a user detecting device;
a microcontroller;
a first blend center unit;
a second blend center unit;
a first HID (human interface device);
a second HID (human interface device);
the receptacle comprising a front opening;
the access panel being laterally integrated onto the front opening;
the access panel being operably coupled to the receptacle, wherein operating the access panel enables access into the receptacle;
the first HID, the second HID, the display device, and the user detecting device being laterally integrated onto the access panel;
the display device and the user detecting device being electronically coupled to the microcontroller;
the display device being operably coupled to the user detecting device, wherein the display device is actuated by the user detecting device;
the first blend center unit being mounted adjacent to the first HID;
the second blend center unit being mounted adjacent to the second HID;
the first HID being operably coupled to the first blend center unit, wherein operating the first HID governs dispensing of a windshield washer solution from the first blend center unit into the at least one liquid dispenser; and
the second HID being operably coupled to the second blend center unit, wherein operating the second HID governs dispensing of a cleaning solution from the second blend center unit into the at least one liquid dispenser.

16. The dispensing system of claim 15, comprising:
a first concentrate container;
a first concentrate suction tube;
a water supply tube;
a first mixed product dispenser tube;
the first concentrate container, the first concentrate suction tube, and the water supply tube being mounted within the receptacle;
the first concentrate container being mounted adjacent to the bottom side of the receptacle;
the first concentrate suction tube being in fluid communication with the first concentrate container and the first blend center unit;
the first blend center unit being in fluid communication with the first concentrate suction tube and the water supply tube;
the first mixed product dispenser tube extending from the first blend center unit, wherein the first mixed product dispenser tube is in fluid communication with the first blend center unit; and
the first mixed product dispenser tube being oriented towards the at least one liquid dispenser.

17. The dispensing system of claim 16, comprising:
a wall;
a shelf;
a water inlet valve;
an inlet water source;
the back side of the receptacle being detachably mounted to a front side of the wall via a plurality of fasteners;
the shelf being mounted to the wall, positioned below the receptacle;
the water inlet valve being mounted to the side of the receptacle; and
the water supply tube being connected to the inlet water source through the water inlet valve.

18. The dispensing system of claim 16, comprising:
a pedestal;
a shelf;
a water inlet valve;
an inlet water source;
the back side of the receptacle being detachably mounted to a front side of the pedestal via a plurality of fasteners;
the shelf being mounted to the pedestal, positioned below the receptacle;
the water supply tube traversing through the back side of the receptacle;
the water supply tube being connected to the water inlet valve;
the water inlet valve being mounted to the side of the pedestal; and
the water supply tube being connected to the inlet water source via the water inlet valve.

19. The dispensing system of claim 15, comprising:
a second concentrate container;
a second concentrate suction tube;
a water supply tube;
a second mixed product dispenser tube;
the second concentrate container, the second concentrate suction tube, and the water supply tube being mounted within the receptacle;
the second concentrate container being mounted adjacent to the bottom side of the receptacle;
the second concentrate suction tube being in fluid communication with the second concentrate container and the second blend center unit;
the second blend center unit being in fluid communication with the second concentrate suction tube and the water supply tube;
the second mixed product dispenser tube extending from the second blend center unit, wherein the second mixed product dispenser tube is in fluid communication with the second blend center unit; and
the second mixed product dispenser tube being oriented towards the at least one liquid dispenser.

20. The dispensing system of claim 15, comprising:
an electric casing;
a wireless communication module;
a power source;
a power cord;
the electric casing being mounted within the receptacle;
the microcontroller, the wireless communication module, and the power source being mounted within the electric casing;
the wireless communication module being electronically connected to the microcontroller;
the power source being electrically connected to the microcontroller;
the power cord being electrically connected to the power source; and
the power cord extending out of the receptacle.
